(19) United States
(12) Patent Application Publication
(10) Pub. No.: US 2026/0012728 A1
(43) Pub. Date: Jan. 8, 2026

(54) SYSTEMS AND METHODS FOR AUDIO MIXING AND RECORDING

(71) Applicant: Ailurus Limited, Hong Kong (HK)

(72) Inventor: Ang Li, Hong Kong (HK)

(73) Assignee: Ailurus Limited, Hong Kong (HK)

(21) Appl. No.: 19/228,330

(22) Filed: Jun. 4, 2025

Related U.S. Application Data
(60) Provisional application No. 63/667,486, filed on Jul. 3, 2024.

(51) Int. Cl. H04R 3/00; H04R 1/08; H04R 17/02

(52) U.S. Cl. CPC H04R 3/005; H04R 1/08; H04R 17/02; H04R 2420/07; H04R 2420/09

(57) ABSTRACT

Disclosed herein are systems and methods for mixing and recording calls on mobile devices and computers using an external audio recorder. In one example, an audio recorder can include a connector configured to connect to a client device, a microphone module, and a digital signal processor configured to process input audio signals received from the client device via the connector and from the microphone module. The audio recorder can be configured to receive a first input audio signal from the client device via the connector, receive a second input audio signal from the microphone, process the first and second input audio signals using the digital signal processor to generate an output audio signal, and loop back the output audio signal back to the client device.

### CROSS-REFERENCE TO RELATED APPLICATIONS

This application claims the benefit of U.S. Provisional Application No. 63/667,486, filed Jul. 3, 2024. The prior application is incorporated herein by reference in its entirety.

### FIELD

The present disclosure relates to audio recording technologies, specifically to systems and methods for mixing and recording calls on mobile devices and computers.

### BACKGROUND

In the era of smartphones and remote work, many client devices (for example, mobile phones, tablets, and laptops) lack the capability to record audio during phone calls and/or online meetings. Additionally, recording calls and meetings via video conference software typically involves complex audio processing due to privacy restrictions on audio channels. Recording software typically requires multiple steps to set up, suffers from slow start-up times, and is sometimes costly. Recording software (for example, audio recording applications running on the client device) often require setting up third-party connections with a prepaid third party number, which increases costs while providing poor recording quality. Furthermore, audio recording applications cannot achieve local recording, thereby reducing the privacy of the communications.

There is a pressing need for a simple, convenient, reliable, and locally processed method of private recording.

### SUMMARY

The foregoing and other objects, features, and advantages of the disclosed technology will become more apparent from the following detailed description, which proceeds with reference to the accompanying figures.

In one aspect, an audio recorder can include a connector configured to connect to a client device, a microphone module, and a digital signal processor configured to process input audio signals received from the client device via the connector and from the microphone module. The audio recorder can be configured to receive a first input audio signal from the client device via the connector, receive a second input audio signal from the microphone, process the first and second input audio signals using the digital signal processor to generate an output audio signal, and loop back the output audio signal back to the client device.

In one aspect, a method can include connecting a client device to a connector of an audio recorder, connecting a peripheral audio device to the audio recorder, receiving a first input audio signal from the client device, receiving a second input audio signal from the peripheral audio device, processing the first input audio signal and the second input audio signal to generate an output audio signal, transmitting the output audio signal to the peripheral audio device, and looping back the output audio signal to the client device.

### BRIEF DESCRIPTION OF THE DRAWINGS

FIG. 1 is a perspective view of an audio recorder configured to mix and record audio, according to one example.

FIG. 2 is a front view of the audio recorder of FIG. 1.

FIG. 3 is a schematic block diagram of an audio recorder configured to mix and record audio, according to one example.

FIG. 4 is a data flow diagram illustrating the flow of data through the audio recorder of FIG. 3, a client device connected to the audio recorder, and other peripheral audio devices connected to the audio recorder.

FIG. 5 is a flowchart that illustrates a method of mixing and recording audio, according to one example.

### DETAILED DESCRIPTION

### Explanation of Terms

For purposes of this description, certain aspects, advantages, and novel features of the embodiments of this disclosure are described herein. The disclosed methods, apparatus, and systems should not be construed as being limiting in any way. Instead, the present disclosure is directed toward all novel and nonobvious features and aspects of the various disclosed embodiments, alone and in various combinations and sub-combinations with one another. The methods, apparatus, and systems are not limited to any specific aspect or feature or combination thereof, nor do the disclosed embodiments require that any one or more specific advantages be present or problems be solved.

Although the operations of some of the disclosed embodiments are described in a particular, sequential order for convenient presentation, it should be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

As used in this disclosure and in the claims, the singular forms “a,” “an,” and “the” include the plural forms unless the context clearly dictates otherwise. Additionally, the term “includes” means “comprises.” Further, the terms “coupled” and “associated” do not exclude the presence of intermediate elements between the coupled or associated items absent specific contrary language.

Although there are alternatives for various components, dimensions, parameters, operating conditions, etc., set forth herein, that does not mean that those alternatives are necessarily equivalent and/or perform equally well. Nor does it mean that the alternatives are listed in a preferred order unless stated otherwise.

As used herein, an audio signal processing module is a component within an electronic device that is responsible for manipulating audio signals to achieve desired effects or improvements. This processing can include tasks such as deserialization, channel syncing, sound effect addition, noise cancellation, sampling compression, mixing, splitting, and encoding. The module typically includes a digital signal processor (DSP) that performs these operations in real-time to enhance the quality and functionality of audio data being transmitted or recorded.

As used herein, a storage module is a component within an electronic device that is responsible for storing digital data, including audio recordings. The storage module can comprise built-in flash memory or an external memory card, such as a micro SD card. It is configured to save mixed audio signals in real-time, allowing for the retrieval, playback, and transfer of recorded audio files. The storage module ensures that audio data is securely and efficiently stored for future access and processing.

As used herein, a power management module is a component within an electronic device that is responsible for managing the distribution and regulation of electrical power to various other modules and components. The power management module typically draws power from an external source, such as a terminal device via a USB or Lightning interface, and supplies it to other modules within the device, including the audio signal processing module, Bluetooth module, storage module, and display module. It may also include a rechargeable battery to provide backup power when the external source is not available, ensuring continuous operation of the device.

As used herein, a “USB connector” is any of a USB-A connector, a USB-B connector, a Micro-USB connector, a Mini-USB connector, and a USB-C connector.

### Overview of the Disclosed Technology

Many client devices (for example, mobile phones, tablets, and laptops) lack the capability to record audio during phone calls, which presents a significant challenge in the era of smartphones and remote work. Additionally, recording meetings via video conference software on computers and tablets often involves complex audio mixing due to privacy restrictions on audio channels. These limitations hinder the ability to capture important conversations and meetings efficiently and securely.

Current solutions for recording audio during calls and video conferences are fraught with several disadvantages. Recording software typically requires multiple steps to set up, suffers from slow start-up times, and is costly. Call recording applications on mobile phones often necessitate setting up third-party calls with a prepaid third-party phone number, which increases telecommunications costs while providing poor recording quality. These methods cannot achieve local recording, thereby reducing the privacy of the calls. Furthermore, existing solutions often fail to provide a simple, convenient, and reliable method for private recording.

Disclosed herein are examples of an audio recorder (which is also referred to herein as a “Bluetooth adapter,” “audio recording adapter,” “attachment,” “Bluetooth attachment,” and/or “audio recording attachment”). The audio recorder can be configured to receive audio data from a connected client device that is engaged in a call, video conference, or any other activity involving client device-side audio output. The audio recorder can be configured to process the received audio data, output the processed audio data to an audio device connected to the client device, and save the processed audio data. In some examples, the audio recorder can further collect ambient audio data using microphones built into the adapter, mix the audio data received from the client device with the ambient audio data, and saved the mixed audio data in real time. In some examples, the audio recorder can further route the mixed audio data to the client device, thereby allowing applications installed on the client device to receive the mixed audio data in real time for recording, speech-to-text conversion, and/or AI processing. In some examples, the audio recorder can further route the mixed audio data to an external audio device (for example, headphones), such that the user of the client device can listen to the mixed audio data. In this way, the audio recorder can locally mix and record audio data in a simple, convenient, and reliable way that maintains privacy, thereby solving the inconvenience of recording calls and conferences on client devices.

Also disclosed herein are examples of a method for recording audio from calls or video conferences via an external Bluetooth adapter, comprising a connector, processor, and audio data storage. This approach addresses the inconvenience of recording calls and conferences on devices like smartphones. The Bluetooth adapter connects to a terminal device via a USB or Lightning interface to exchange audio, operational signal, and application data. The Bluetooth adapter also connects to Bluetooth headsets or audio devices via Bluetooth protocol to exchange audio data and operational signal, with an optional connection to wired headsets via a 3.5 mm audio jack.

### Embodiments of the Disclosed Technology

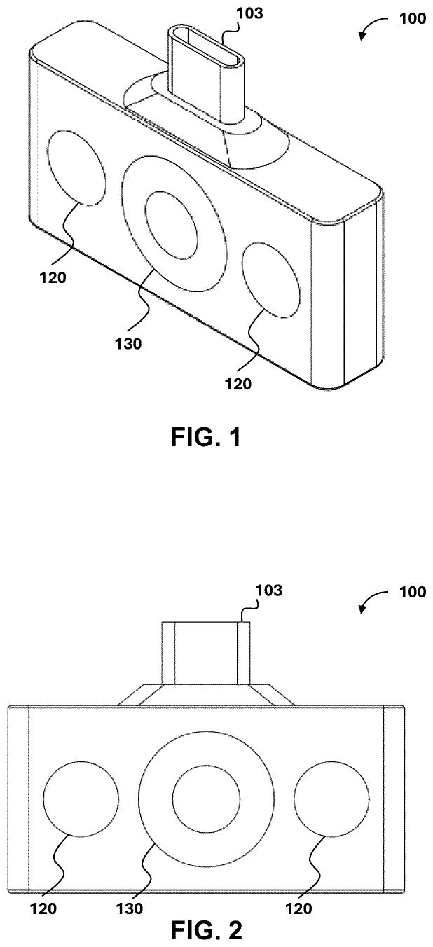

FIGS. 1-2 are perspective and front views, respectively, of an exemplary audio recorder 100 configured to mix and record audio from a client device engaged in a call or video conference. The audio recorder 100 is also referred to herein as a “Bluetooth adapter,” “audio recording adapter,” “attachment,” “Bluetooth attachment,” and/or “audio recording attachment.” Although some examples of the audio recorder 100 are described as Bluetooth devices, it should be understood that the present disclosure is not limited to audio recorders with Bluetooth capability. Rather, it should be understood that the audio recorder 100 can connect to another device (for example, a client device or an external audio device) using any type of wired or wireless connection, including but not limited to Wi-Fi, cellular networks (4G LTE and 5G), and Zigbee.

The audio recorder 100 can include a connector 103, at least one microphone 120, and a control interface 130.

The connector 103 can be configured to be connected to a client device, thereby allowing the audio recorder 100 to draw power from the client device and power the various components of the audio recorder 100. For example, as shown, the connector 103 can be a male USB-C connector configured to be received in a corresponding USB-C socket of a mobile device, a tablet, or a laptop. However, the connector 103 can be any connector, including but not limited to any one of a USB connector (for example, a USB-A connector, a USB-B connector, a mini-USB connector, or a micro-USB connector), a Lightning connector, and any suitable connector capable of connecting to a client device.

In some examples, a battery can be electrically connected to the connector 103. The battery can be a rechargeable battery configured to provide power to the audio recorder 100 when electrical power is not drawn from the client device and through the connector 103 to power the audio recorder 100.

The at least one microphone 120 can include either a single microphone or a plurality of microphones. For example, as shown, the audio recorder 100 can include two microphones 120. The at least one microphone 120 can be configured to collect audio data, including any combination of audio output from a speaker of the client device, audio output from an audio device (for example, headphones connected to the client device), and ambient noise from the environment surrounding the client device.

The at least one microphone 120 can be any one of or any combination of a piezoelectric microphone, a condenser microphone, and a MEMS microphone. For example, the at least one microphone 120 can be a piezoelectric microphone coupled to the connector 103. In some examples, the piezoelectric microphone can be hard-connected or rigidly connected to the connector 103. This can allow vibrations from the client device's speaker (for example, an earpiece speaker) to be transferred across the body of the client device, through the connector 103, and to the piezoelectric microphone for recording. This can beneficially allow sound emitted from the speaker of the client device to be captured by the audio recorder 100, such that both sides of a phone call can be recorded when the user is not speaking through a peripheral audio device (for example, a wired or wireless headset).

The control interface 130 can be configured to activate or deactivate one or more functions of the audio recorder 100. Although this component is illustrated as a button, it should be understood that the control interface 130 can be any suitable interface, including but not limited to a dial, a touchscreen, a slider, a toggle, etc. Exemplary functions activated or deactivated by the control button 130 can include, but are not limited to, pairing the audio recorder 100 and a client device or an audio device, starting or ending recording, starting or ending audio playback, adjusting volume, powering the audio recorder 100 on or off, quick audio features, etc. In some examples, the audio recorder 100 can be implemented with display features that provide an indication of the function or status of the audio recorder 100.

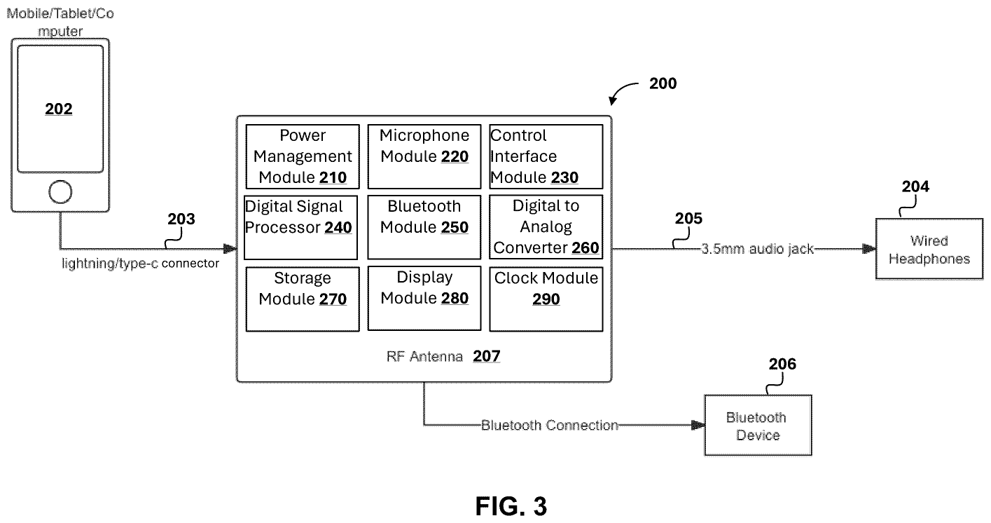

FIG. 3 is a schematic block diagram of an audio recorder 200 configured to mix and record audio, according to one example.

As shown, the audio recorder 200 can be configured to connect to a client device 202 (which is also referred to herein as a “terminal device”). The client device 202 can be any device capable of receiving and emitting sound, for example, when engaged in a call or a video conference. Examples of the client device 202 include, but are not limited to, a mobile phone, a tablet, and a personal computer. In some examples, the client device 202 can have Bluetooth capability. In some examples, the client device 202 can include a connector 203 adapted to receive a corresponding connector of the audio recorder 200. The connector 203 can be any suitable connector configured to connect to the client device 202. Example connectors 203 may include, but are not limited to, USB connectors (for example, USB-C connectors) and Lightning connectors.

As further shown, the audio recorder 200 can be configured to be connected over a wired connection to a wired audio device 204 (which is also referred to herein as a “wired headset” and/or a “wired peripheral audio device”). Although the present disclosure may refer to the wired audio device 204 as a wired headset, examples of the wired audio device 204 include, but are not limited to, a headset, a speaker, a microphone, and a telephone handset. The audio recorder 200 can include an audio jack 205, which can be a 3.5 millimeter audio jack configured to receive a corresponding plug of the wired audio device 204.

As further shown, the audio recorder 200 can be configured to be wirelessly connected to a wireless audio device 206 (which is also referred to herein as a “Bluetooth device” and/or a “wireless peripheral audio device”). Examples of the wireless audio device 206 include, but are not limited to, a headset, a speaker, a microphone, and a telephone handset. The audio recorder 200 can include a RF antenna 207. The RF antenna 207 can be configured, optionally in conjunction with a Bluetooth module 250, to transmit data to and receive data from the wireless audio device 206, for example, over a wireless radio connection. Although the present disclosure primarily refers to the wireless connection between the audio recorder 200 and the wireless audio device 206 as a Bluetooth connection. However, it should be understood that other types of wireless connections, including but not limited to Wi-Fi, cellular networks (4G LTE and 5G), and Zigbee, can be used instead of a Bluetooth connection.

The audio recorder 200 can be configured to connect to both the wired audio device 204 and the wireless audio device 206, just the wired audio device 204, or just the wireless audio device 206. In some examples, the audio recorder 200 can be configured to connect to multiple client devices 202, multiple wired audio devices 204, and/or multiple wireless audio devices 206.

As shown, the audio recorder 200 includes a power management module 210, a microphone module 220, a control interface module 230, a digital signal processor 240, a Bluetooth module 250, a digital-to-analog converter 260, a storage module 270, a display module 280, and a clock module 290.

The power management module 210 can be configured to manage the distribution and regulation of electrical power to other modules and components of the audio recorder 200. The power management module 210 can be configured to draw power from an external source, such a wall socket, a battery, the client device 202, etc. For example, the power management module 210 can include a connector, such as a USB or Lightning connector. The USB or Lightning connector can be connected to a corresponding connector of the client device 202, and electrical power can be transferred from the client device 202 to the power management module 210. In some examples, the power management module 210 may additionally or alternatively include a rechargeable battery to provide backup power when the external source is not available, thus ensuring continuous operation of the device.

The microphone module 220 can include one or more microphones configured to capture audio, encode the audio in an input audio signal (which is also referred to herein as an “audio recorder input audio signal”), and send the input audio signal to the digital signal processor 240 for processing. The microphones can be configured to capture audio from a speaker of the client device 202, audio from the user of the client device 202, audio from the wired audio device 204, audio from the wireless audio device 206, and/or ambient audio from the surrounding environment. The microphones can be any combination of piezoelectric microphones, condenser microphones, dynamic microphones, ribbon microphones, and MEMS microphones. For example, the microphone module 220 can include a piezoelectric microphone coupled to the connector of the power management module 210. The piezoelectric microphone can capture vibrations from an earpiece speaker of the client device 202 that are transferred across the body of the client device 202, through the connector, and to the piezoelectric microphone. This can beneficially allow the audio recorder 200 to capture sound emitted from the earpiece speaker of the client device 202.

The digital signal processor 240 can be configured to receive and process input audio signals from any combination of the client device 202, the wired audio device 204, the wireless audio device 206, and/or the microphone module 220. In some examples, the digital signal processor 240 can receive an input audio signal from the client device 202 via the connector 203. The input audio signal can be real-time audio data that the client device 202 outputs when engaged in a call, a video conference, or any other activity in which the client device 202 generates sound. In some examples, the digital signal processor 240 can additional or alternatively receive an input audio signal from the wired audio device 204 via the audio jack 205. In some of these examples, the input audio signal from the wired audio device 204 can be processed using an analog-to-digital converter before being received by the digital signal processor 240. In some examples, the digital signal processor 240 can additional or alternatively receive an input audio signal from the wireless audio device 206 via the RF antenna 207 and/or the Bluetooth module 250. In some examples, the digital signal processor 240 can additional or alternatively receive an input audio signal from the microphone module 220. In some of these examples, the input audio signal from the microphone module 220 can be an ambient audio signal.

The digital signal processor 240 can be configured to execute processes such as (de) serialization, channel syncing, sound effect, noise cancellation, sampling compression, mixing, splitting, encoding, etc. For example, the digital signal processor 240 can mix, synchronize, balance, and/or otherwise process an input audio signal from the client device 202 with an input audio signal received from the wired audio device 204 and/or the wireless audio device 206, resulting in an output audio signal that reflects the audio of the call, video conference, or other client device activity. Additionally or alternatively, the digital signal processor 240 can split the input audio signal received from the client device 202 from the ambient audio signal received from the microphone module 220. In this way, the digital signal processor 240 can cancel unwanted noise from the output audio signal. The signal processor 240 can operate in real time.

In some examples, the output audio signal can be relayed to the client device 202 via the connector 203. For example, the output audio signal can be looped back to the client device 202 through a vacant audio channel (for example, a monitor channel) in the interface of the connector 203. The interface of the connector 203 includes, but is not limited to, a USB interface and a Lightning interface. This can allow applications installed on the client device 202 to receive the output audio in real-time for recording, audio-to-text conversion, storage, artificial intelligence processing, or any other uses.

In some examples, the output audio signal can be additionally or alternatively relayed to the wireless audio device 206. For example, digital-to-analog converter 260 can relay the output audio signal from the digital signal processor 240 to the wireless audio device 206 via the RF antenna 207 and/or the Bluetooth module 250.

In some examples, the output audio signal can be additionally or alternatively relayed to the wired audio device 204. For example, digital-to-analog converter 260 can relay the output audio signal from the digital signal processor 240 to the wired audio device 204 via the audio jack 205. In some examples where the audio recorder 200 is not configured to connect to the wired audio device 204, the digital-to-analog converter 260 and/or the audio jack 205 can be omitted.

The storage module 270 can be configured to store the output audio signal as an audio file. In some examples, the storage module 270 can store the output audio signal in real time. The storage module 270 can be any combination of built-in flash memory or an external micro SD card.

The control module 230 can be configured to receive input from a user of the audio recorder 200. The control module 230 can be any combination of a button, a dial, a touchscreen, a slider, a toggle, etc. The user input can be a command to start or stop a function. Example functions triggered by the control module 230 include, but are not limited to, power on/off of the audio recorder 200, Bluetooth headset pairing and connection, start/end recording, start/end play of calls, volume adjustment, and quick audio features, etc. For example, the control module 230 can be a button that activates a recording mode in which the audio recorder 200 records audio emitted by the client device 202. The inclusion of the control module 230 can thus allow the audio recorder 200 to be operated independently of the client device 202, the wired audio device 204, and/or the wireless audio device 206.

In some examples, the audio recorder 200 can be controlled by the client device 202, the wired audio device 204, and/or the wireless audio device 206. For example, an application running on the client device 202 can send a command to the audio recorder 200 to play back an audio file stored in the storage module 270. The contents of the audio file (for example, the output audio signal) can be looped back through the connector 203 to an input channel of the client device 202. The contents of the audio file (for example, output audio signal) can also be routed to any combination of the client device 202, the wired audio device 204, and/or the wireless audio device 206 such that the user can hear the audio being played back. In such examples, since the controls for operating the audio recorder 200 are on the client device 202, the wired audio device 204, and/or the wireless audio device 206, the audio recorder can lack the control module 230.

The display module 280 can be configured to display status or other information to the user. The display module 280 can include any combination of LED indicators, display screens, etc. that work with the control module 230 to implement and display functions of the audio recorder 200. Example functions displayed by the display module 280 include, but are not limited to, power on/off of the audio recorder 200, Bluetooth headset pairing and connection, start/end recording, start/end play of calls, volume adjustment, and quick audio features, etc.

In such examples, the client device 202, the wired audio device 204, and/or the wireless audio device 206 can display the status or function of the audio recorder 200. In such examples, the audio recorder can lack the display module 280.

An optional clock module 290 can be configured to provide the current time to accurately and independently record the timing of recordings. In some examples, the clock module 290 can be powered by an onboard rechargeable battery.

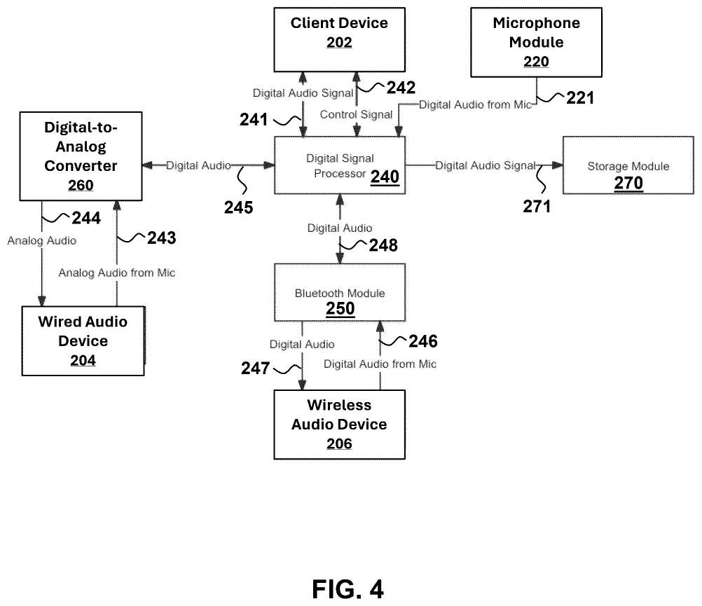

FIG. 4 is a data flow diagram illustrating the flow of data through the audio recorder 200, the client device 202, the wired audio device 204, and the wireless audio device 206.

As shown, digital audio signals 241 (for example, an input audio signal and an output audio signal) can be passed between the client device 202 and the digital signal processor 240. The input audio signal can encode audio from a call or video conference in which the client device 202 is engaged. The input audio signal can additionally or alternatively encode audio captured by a microphone of the client device 202. Audio captured by the microphone of the client device 202 can include audio emitted by a speaker of the client device 202, the user's voice, ambient audio, etc. The input audio signal can be processed by the digital signal processor 240.

In some examples, the microphone of the client device 202 can be configured to capture audio upon the determination that neither of the wired audio device 204 nor the wireless audio device 206 are connected to the audio recorder 200.

The output audio signal can encode audio that was recorded or mixed by the audio recorder 200 and can be played back, stored, or further processed by the client device 202.

In some examples, a control signal 242 can be passed between the client device 202 and the digital signal processor 240. The control signal 242 can be generated by the client device 202 and can be used to control one or more functions of the audio recorder 200.

The wired audio device 204 can be configured to generate an analog input audio signal 243. In some examples, the analog input audio signal 243 can encode audio captured by an analog microphone of the wired audio device 204. In some examples, the analog input audio signal 243 can be received by the digital-to-analog converter 260, which can exchange audio data with the digital signal processor 240 via a digital audio signal 245. In such examples, the digital-to-analog converter 260 can be configured to both convert digital signals to analog signals and also convert analog signals to digital signals.

The wired audio device 204 can be configured to receive an output analog audio signal 244 from the digital-to-analog converter 260. The output analog audio signal 244 can encode the output audio signal, in other words, the output of the digital signal processor 240. The wired audio device 204 can be configured to play to the user the contents of the output analog audio signal 244.

In some examples, data is only transferred to or from the digital-to-analog converter 260 if the wired audio device 204 is connected to the audio recorder 200.

The Bluetooth module 250 can be configured to relay audio data between the wireless audio device 206 and the digital signal processor 240. The Bluetooth module 250 can be configured to receive a digital input audio signal 246 from a microphone of the wireless audio device 206 and relay this data to the digital signal processor 240 via a digital audio signal 248. The Bluetooth module 250 can be further configured to relay the output audio signal generated by the digital signal processor 240 to the wireless audio device 206 via a digital output audio signal 247. The wireless audio device 206 can be configured to play to the user the contents of the digital output audio signal 247.

In some examples, data is only transferred to or from the Bluetooth module 250 if the wireless audio device 206 is connected to the audio recorder 200.

It should be understood that audio data can be relayed between the audio recorder 200, the client device 202, and/or the wireless audio device 206 using wireless communication protocols other than Bluetooth. Such other wireless communication protocols include, but are not limited to, Wi-Fi, cellular networks (4G LTE and 5G), and Zigbee. In such examples, the Bluetooth module 250 may generically be referred to as a “wireless communication module.”

The microphone module 220 can be configured to send a digital input audio signal 221 (which is also referred to herein as a “microphone module input audio signal” and/or a “microphone input audio signal”) to the digital signal processor 240. In some examples, the digital input audio signal 221 encode ambient audio captured by the microphone module 220. In some examples, the digital input audio signal 221 can encode vibrations from the client device's speaker (for example, an earpiece speaker) captured by a piezoelectric microphone of the microphone module 220. This can beneficially allow the audio recorder 200 can capture audio from the client device 202 even if the speaker of the client device 202 is not activated.

The storage module 270 can be configured to receive an output digital audio signal 271. The output digital audio signal 271 can encode the output audio signal (in other words, the mixed and recorded audio) generated by the digital signal processor 240. The storage module 270 can store the contents of the output digital audio signal 271.

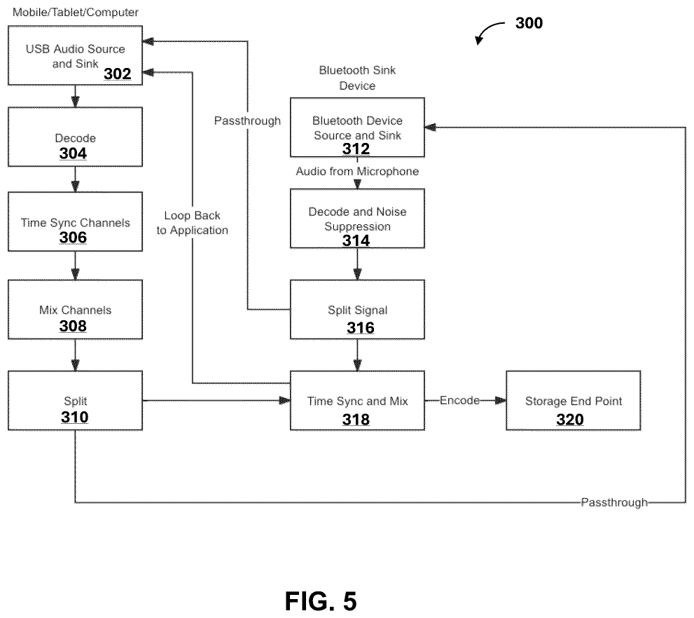

FIG. 5 is a flowchart 300 that illustrates a method of mixing and recording audio, according to one example. The method can be performed by an audio recorder (for example, any one of audio recorders 100, 200).

At block 302, an input audio signal is received from a client device (for example, client device 202 shown in in FIGS. 2-3) by the audio recorder. In some examples, the input audio signal can encode audio captured by a microphone of the client device. In some examples, the input audio signal can encode audio data configured to be output from a speaker of the client device.

As shown in FIG. 5, the input audio signal can be received via a connector (for example, the connectors 103 shown in FIG. 1 or the connector 203 shown in FIG. 2) connected to the client device. The connector can be a Lightning or USB connector, but can alternatively be any connector capable of connecting to the client device.

At block 304, the input audio signal from the client device is decoded. At block 306, the different channels of the input audio signal can be time synchronized.

At block 308, the synchronized input audio signal can be can be mixed.

At block 310, the mixed input audio signal can be can be split into different portions. A non-passed through portion of the split input audio signal can be provided can be provided to a digital signal processor (for example, the digital signal processor 240 shown in FIGS. 2-3) of the audio recorder for processing at block 318. A passed through portion of the split input audio signal can be passed through to the peripheral audio device at block 312. The peripheral audio device can then play, process, or otherwise consume the passed through portion of the split input audio signal.

At block 312, an input audio signal from a peripheral audio device (for example, the wired audio device 204 and/or the wireless audio device 206 shown in FIGS. 2-3) can be received by the audio recorder. The input audio signal from the peripheral audio device can encode audio captured by a microphone of the peripheral audio device. In the illustrated example, the input audio signal can be received from the peripheral audio device over a Bluetooth connection (for example, via the RF antenna 207 shown in FIG. 2 and/or Bluetooth module 250 shown in FIGS. 2-3). In some examples, the input audio signal can be received from the peripheral audio device via any type of wireless connection. In some examples, the input audio signal can be received from the peripheral audio device via a wired connection, for example, via a 3.5 millimeter audio jack. In some examples, the step of block 312 can additionally or alternatively include receiving a first portion of the mixed audio signal split at block 310. In such examples, the input audio signal received at block 312 can encode audio captured by the microphone of the client device.

At block 314, the input audio signal from the peripheral audio device can be decoded. In some examples, ambient noise can be removed from the input audio signal using noise cancellation techniques.

At block 316, the input audio signal can be split into multiple portions. A passed through portion of the split input audio signal can be passed through to the client device at block 302. For example, the passed through portion of the split input audio signal can be passed through to the client device via an audio channel separate from the upstream audio provided to the audio recorder. The passed through first portion of the split input audio signal can be provided to an application running on the client device. The client device (or an application running thereon) can play, process, or otherwise consume the passed through portion of the split input audio signal.

A non-passed through portion of the split input audio signal can be passed to a digital signal processor (for example, the digital signal processor 240 shown in FIGS. 2-3) of the audio recorder at block 318. The non-passed through portions of the input audio signals from the client device and the peripheral audio device can be time synchronized, mixed, resampled, compressed, and/or encoded by the digital signal processor, thereby resulting in an output audio signal. The output audio signal can be looped back to the client device at block 302, for example, by looping the output audio signal back via a vacant audio channel (for example, a monitor channel) in the interface of the connector connecting the audio recorder and the client device. In some examples, the looped-back output audio signal can be saved on the client device. In some examples, the looped-back output audio signal can be processed by an application installed on the client device to transcribe the output audio to text and/or to process the output audio with artificial intelligence (for example, to summarize the output audio or perform a natural language search).

At block 320, the output audio signal can be saved to a storage module (for example, the storage module 270 shown in FIGS. 2-3) of the audio recorder. Using an interface on the client device or a physical control (for example, the control interface shown in FIG. 2) on the audio recorder, a user can trigger the playback of the output audio signal on the peripheral audio device and/or the client device. In some examples, the user can operate the interface to send the saved output audio signal back to the client device for processing after mixing.

In view of the many possible embodiments to which the principles of the disclosed technology may be applied, it should be recognized that the illustrated embodiments are only preferred examples and should not be taken as limiting the scope of the disclosure. Rather, the scope of the disclosure is at least as broad as the following claims and equivalents of the recited features. We therefore claim all that comes within the scope and spirit of these claims.

1. An apparatus comprising:
a connector configured to connect to a client device;
a microphone module; and
a digital signal processor configured to process input audio signals received from the client device via the connector and from the microphone module;
wherein the apparatus is configured to:
receive a first input audio signal from the client device via the connector;
receive a second input audio signal from the microphone module;
process the first and second input audio signals using the digital signal processor to generate an output audio signal; and
loop back the output audio signal back to the client device.

2. The apparatus of claim 1, wherein the connector is a USB connector.

3. The apparatus of claim 1, wherein the connector is a Lightning connector.

4. The apparatus of claim 1, further comprising a power management module configured to power the apparatus, wherein the power management module is configured to draw power from the client device via the connector.

5. The apparatus of claim 1, further comprising a wireless communication module, wherein the wireless communication module is configured to receive a third input audio signal from a wireless audio device and transmit the output audio signal to the wireless audio device.

6. The apparatus of claim 5, wherein the wireless communication module is a Bluetooth module.

7. The apparatus of claim 1, further comprising a digital-to-analog converter, wherein the digital-to-analog converter is configured to receive an analog input audio signal from a wired audio device via an audio jack and relay the output audio signal from the digital signal processor to the wired audio device via the audio jack.

8. The apparatus of claim 1, wherein the microphone module includes a piezoelectric microphone rigidly connected to the connector.

9. The apparatus of claim 1, further comprising a storage module configured to store the output audio signal.

10. A method comprising:
connecting a client device to a connector of an audio recorder;
connecting a peripheral audio device to the audio recorder;
receiving a first input audio signal from the client device;
receiving a second input audio signal from the peripheral audio device;
processing the first input audio signal and the second input audio signal to generate an output audio signal;
transmitting the output audio signal to the peripheral audio device; and
looping back the output audio signal to the client device.

11. The method of claim 10, wherein the connector is a USB connector.

12. The method of claim 10, wherein the connector is a Lightning connector.

13. The method of claim 10, wherein the peripheral audio device is a wireless audio device, and wherein transmitting the output audio signal to the peripheral audio device comprises relaying the output audio signal from the audio recorder to the peripheral audio device via a wireless connection.

14. The method of claim 13, wherein the wireless connection is a Bluetooth connection.

15. The method of claim 10, wherein the peripheral audio device is a wired audio device, and wherein transmitting the output audio signals to the peripheral audio device comprises:
converting the output audio signal to an analog output audio signal; and
relaying the output audio signal from the audio recorder to the wired audio device.

16. The method of claim 10, further comprising, before processing the first input audio signal and the second input audio signal, capturing vibrations from a speaker of the client device using a piezoelectric microphone of the audio device to generate a third input audio signal.

17. The method of claim 16, wherein the piezoelectric microphone is rigidly coupled to the connector of the audio recorder.

18. The method of claim 16, wherein processing the first input audio signal and the second input audio signal comprises processing the first input audio signal, the second input audio signal, and the third input audio signal.

19. The method of claim 10, wherein the client device is engaged in a call or a video conference, and wherein first input audio signal is audio form the call or the video conference.

20. The method of claim 10, further comprising storing the output audio signal using a storage module of the audio recorder.
